(19) United States
(12) Patent Application Publication
(10) Pub. No.: US 2004/0022309 A1
(43) Pub. Date: Feb. 5, 2004

(54) Multiple modem apparatus

(75) Inventors: Joseph Menashe, Bat-Yam (IL); Nir Drori, Rchovot (IL); Ilan Nadav, Tel-Aviv (IL); Zadok Rachamim, Petch-Tikva (IL)

Correspondence Address: Fogg Slifer Polglaze Leffert & Jay, P.A., P.O. box 581009, Minneapolis, MN, 55458-1009, US

(73) Assignee: ADC Telecommunications Israel Ltd.

(21) Appl. No.: 10/210,530

(22) Filed: Aug. 1, 2002

(51) Int. Cl. H04L 5/16; H04B 1/38

(52) U.S. Cl. 375/222

(57) ABSTRACT

The multiple modem apparatus has a number of analog front ends that feed analog signals to and receive analog signals from a modem controller circuit. The modem controller circuit has a codec function for sampling, quantizing, and digitizing the received analog signals. The codec additionally creates an analog signal from digitized signals received from the other side of the modem apparatus. A digital signal processing function provides digital processing of digital signals. An Ethernet device converts digital signals from the modem controller circuit to the Ethernet format and Ethernet signals going to the modem controller circuit are converted from the Ethernet format to digital data. A multiple modem apparatus controller controls the operation of the apparatus while providing synchronization of the multiple analog front ends and routing of data.

### TECHNICAL FIELD

The present invention relates generally to data communications and particularly to data communications in a modem environment.

### BACKGROUND

Modems provide a way for one computer or similar device to send digital data over a communications line to a second computer or similar device. The modem may comply with one or more of various communication standards such as VDSL, HDSL, or G.SHDSL. Different communication standards typically provide different connection speeds and/or symmetrical/asymmetrical operation.

Modems are additionally used in testing communications equipment. For example, a device under test might be an access gateway or router. In order to simulate a large number of subscriber lines being coupled to the device under test, a large quantity of modems are necessary; one modem for each subscriber line into the device under test. The testing equipment is coupled to the device under test through each of the modems.

Using a large number of modems in one location is typically expensive and bulky due to the redundant parts and modules used by each individual modem. There is a resulting need in the art for a modem apparatus that is smaller and less expensive yet functionally equivalent to a relatively large quantity of modems.

### SUMMARY

The embodiments of the present invention encompass a multiple modem apparatus. The apparatus comprises a plurality of modem interfaces that each has analog circuitry for performing modulation and demodulation tasks. A modem controller circuit is coupled to the plurality of modem interfaces. The modem controller circuit has the functionality to convert analog signals from the plurality of modem interfaces to digital signals. An Ethernet device is coupled to the modem controller circuit. The Ethernet device converts the digital signals to Ethernet signals. A controller is coupled to the plurality of modem interfaces. The controller provides control functions for the multiple modem apparatus.

### BRIEF DESCRIPTION OF THE DRAWINGS

FIG. 1 shows a block diagram of one embodiment of a multiple interface modem card of the present invention.

FIG. 2 shows a block diagram of one embodiment of a multiple modem apparatus of the present invention.

FIG. 3 shows a block diagram of one embodiment of a modem system of the present invention.

FIG. 4 shows a flowchart of one embodiment of a multiple modem apparatus communication method of the present invention.

FIG. 5 shows a flowchart of another embodiment of a multiple modem apparatus communication method of the present invention.

### DETAILED DESCRIPTION

The embodiments of the present invention provide a single multiple modem apparatus that substitutes for a number of individual modems. By reducing the size of each modem and eliminating redundant circuits, the individual modems can be integrated into a smaller, less expensive package.

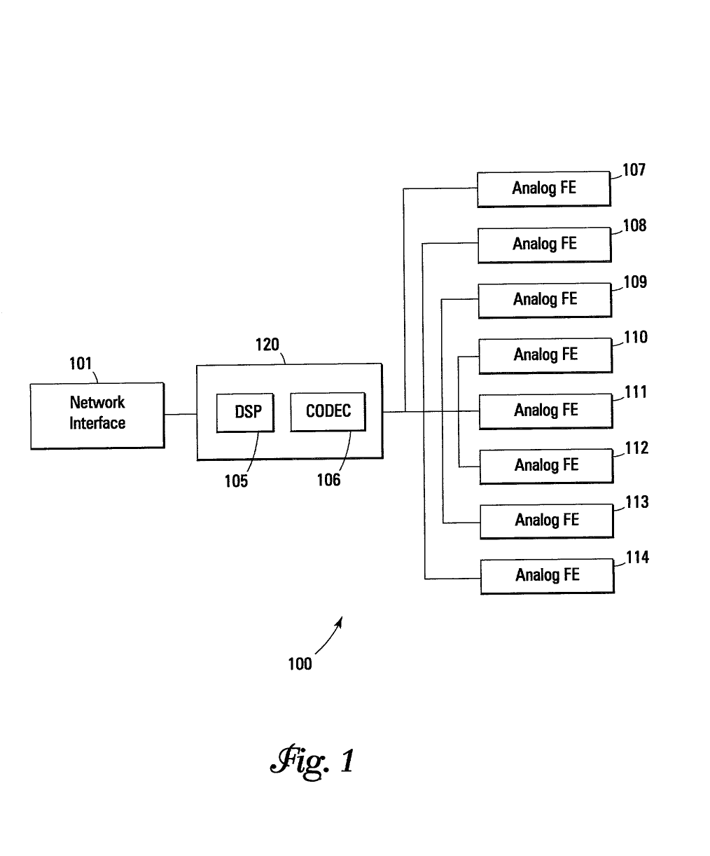

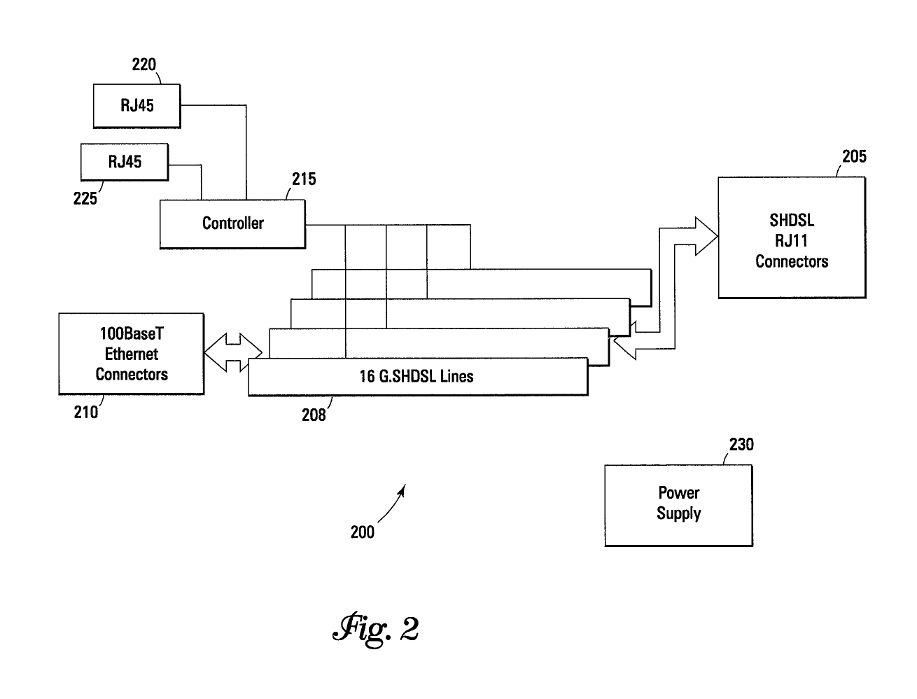

FIG. 1 illustrates a block diagram of one embodiment of a multiple interface modem card (100) of the present invention. The modem card (100) is comprised of a number of analog front ends (107-114). For purposes of clarity, only eight analog front ends (107-114) are shown. One embodiment, as illustrated in FIG. 2, uses sixteen analog front ends. Other embodiments use other quantities of analog front ends.

As is well known in the art, the analog front ends (107-114) are responsible for performing the analog functions of the modem. The analog front ends (107-114) contain the transmitters and receivers for the multiple modem apparatus. The transmitters are responsible for performing the modulation and the receivers are responsible for performing the demodulation for the analog front ends. The type of modulation used (e.g., Quadrature Amplitude Modulation, Quadrature Phase Shift Keying) is dependent on the use of the modem.

In one embodiment, the analog front ends (107-114) also contain additional analog circuitry such as a line splitter, a power booster, a frequency filter, and an impedance adjuster. The functions of the analog circuitry are well known in the modem art and are not discussed further. Alternate embodiments comprise other analog circuitry.

The analog front ends (107-114) are coupled to a coder/decoder function (106) commonly referred to as a codec. The codec (106) is responsible for transforming the analog signals from the analog front ends (107-114) to digital signals and vice versa. This process involves sampling, quantizing, and digitizing.

The sampling is performed at predetermined intervals along a waveform to determine a value of the waveform at particular point in time. Quantizing then replaces that sampled value with the nearest value that is within the range of the modem. The digitizing function converts the quantized value to a digital bit pattern.

The codec (106) is coupled to a digital signal processor function (105) that processes digital signals from the codec (106) to increase the signal-to-noise ratio or other digital processes. The digital signal processor also performs digital processing on the signals to be sent in the opposite direction through the codec (106) to the analog front ends (107-114) for transmission to an analog device.

The digital signal processor (105) is coupled to a network interface (101) that converts the digital signals to a network format and vice versa. In one embodiment, the network interface (101) is an Ethernet device that converts the digital signals to the Ethernet format (IEEE 802.3). The Ethernet device (101) receives data from test equipment (or other electronic equipment) in a standardized Ethernet format, removes the relevant data payload from the Ethernet frame, and transmits the data to the digital signal processor (105). In the opposite direction, the Ethernet device (101) receives digital data from the digital signal processor (105), adds the appropriate header, trailer, and other Ethernet required bits and transmits the Ethernet frame to the test equipment (or other electronic equipment). In alternate embodiments, the Ethernet device (101) transmits or receives data with any electronic device that requires a modem to communicate.

In one embodiment, the codec (106) and digital signal processor (105) functions are part of a single modem controller integrated circuit (120). Alternate embodiments split these functions into multiple integrated circuits. The quantity of modem controller integrated circuits (120) required on a multiple interface modem card (100) is determined by the controlling capabilities of the modem controller integrated circuit (120) (i.e., one modem interface, in this embodiment, is one analog front end). For example, if the modem controller integrated circuit (120) can control only eight modem interfaces and the modem card is comprised of sixteen modem interfaces, at least two modem controller integrated circuits are required for that particular embodiment.

In one embodiment, the modem of FIG. 1 is compliant with the G.SHDSL standard (G.991.2) developed by the International Telecommunications Union (ITU) Telecommunications Standards Sector. This is a standard for symmetric DSL over a single pair of copper wires at rates between 192 kbps and 2.31 Mbps. Alternate embodiments of the modem of the present invention use different communications standards.

FIG. 2 illustrates a block diagram of one embodiment of a multiple modem apparatus (200) of the present invention. The apparatus (200) is comprised of a number of multiple interface modem transceivers (201), each transceiver (201) having a number of modem interfaces as illustrated in FIG. 1. In one embodiment, each modem transceiver (201) has sixteen G.SHDSL modems. Alternate embodiments use different quantities of modems on each card.

If the modem transceiver (201) is comprised of sixteen modems, at least two of the multiple interface modems illustrated in FIG. 1 are needed. Alternate embodiments that use different quantities of modem interfaces require different quantities of multiple interface modems.

On the analog side of the modems, the modem transceivers (201) are coupled to SHDSL connectors (205). In one embodiment, these connectors are RJ11-type connectors. Alternate embodiments use other types of connectors.

On the digital side of the modems, the modem transceivers (201) are coupled to Ethernet connectors (210). In one embodiment, these connectors are RJ45-type connectors (210). Alternate embodiments use other types of connectors.

The quantities of SHDSL connectors (205) and Ethernet connectors (210) are determined by the interface data rate and the type of Ethernet. For example, one embodiment uses 64 SHDSL interfaces at 1.2 Mbps. The data out of the Ethernet side is 64 * 1.2 Mbps=76.8 Mbps. This would require 8 Ethernet connectors of 10 BaseT or one connector at 100 BaseT. Alternate embodiments with different data rates and different quantities of SHDSL connectors can be computed in a similar fashion.

A controller (215) is coupled to the modem transceivers (201). The controller (215) is responsible for performing the control functions required by each of the modem transceivers (201). These operations include synchronization of each modem on the card with other modems, routing of data, and point-to-point protocol processing. Alternate embodiments have the controller perform other modem control tasks.

In one embodiment, the controller (215) is a microprocessor. Alternate embodiments use microcontrollers or other controlling circuitry.

Two management connectors (220 and 225) are coupled to the controller (215) to provide control of the multiple modem apparatus by an outside management device. For example, the outside management device is a computer that is controlling the operation of the multiple modem apparatus in a testing environment.

In one embodiment, one connector is an RJ45 Ethernet connector (220) and the other is a serial RS232 connector (225). Alternate embodiments use different types of management connectors.

Only a single power supply (230) is necessary to power the multiple modem apparatus. The power supply generates all of the different supply voltages required for the apparatus.

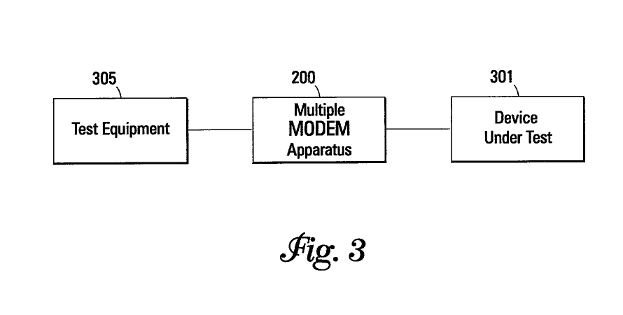

FIG. 3 illustrates a block diagram of one embodiment of a modem system of the present invention. In order to simulate a large number of subscriber lines being coupled to a device under test, the multiple modem apparatus (200) of the present invention couples test equipment (305) to the device under test (301). The multiple modem apparatus (200) permits the test equipment (305) to communicate with the device under test (301).

In one embodiment, the device under test (301) is an access gateway. In another embodiment, the device under test (301) is a network router. The embodiments of the present invention are not limited to any one type of device (301).

The test equipment (305) is any equipment that generates test signals representing or emulating subscriber generated communication signals. The combination of the test equipment (305) and the multiple modem apparatus (200), therefore, can emulate a large network of subscribers communicating with the device under test (301).

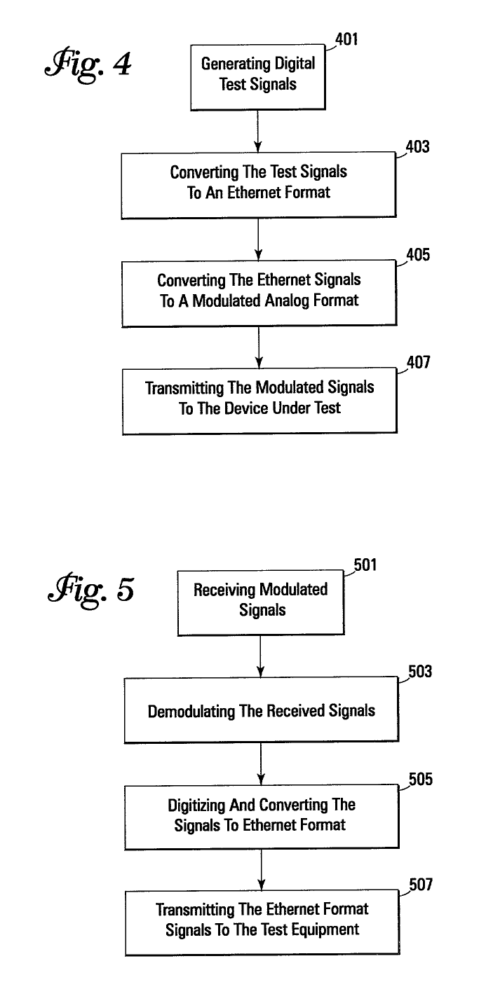

FIG. 4 illustrates a flowchart of one embodiment of a multiple modem apparatus communication method of the present invention. In both embodiments illustrated in FIGS. 4 and 5, one embodiment of the multiple modem apparatus illustrated in FIG. 2 is coupled to a device under test such as a gateway or router and test equipment that generates test signals to test the device under test.

The test equipment generates the digital test signals that represent the subscriber signals (401) as discussed previously. The test signals are converted to Ethernet format signals (403) for use by the multiple mode apparatus of the present invention. The Ethernet signals are converted to a modulated analog format (405) by the multiple modem apparatus for transmission (407) to the device under test.

FIG. 5 illustrates a flowchart of another embodiment of a multiple modem communication method of the present invention. The multiple modem apparatus receives analog signals from the device under test (501). The multiple modem apparatus then demodulates the analog signals (503). The demodulated signals are digitized and converted to an Ethernet format (505). The Ethernet signals are then transmitted to the test equipment (507).

In summary, the embodiments of the multiple modem apparatus of the present invention provide a relatively large quantity of modems in a single box while reducing both the cost and size of the apparatus as compared to the same number of individual modem units. This is accomplished in part by having a single modem control circuit, with both codec and digital signal processing functions, coupled to a number of analog front ends. Additionally, the modem apparatus is controlled by a controller that provides the functions necessary to communicate with and control the apparatus.

Numerous modifications and variations of the present invention are possible in light of the above teachings. It is therefore to be understood that within the scope of the appended claims, the invention may be practiced otherwise than as specifically described herein.

What is claimed is:

1. A multiple modem apparatus comprising:
a plurality of modem interfaces, each modem interface comprising analog circuitry for performing modulation and demodulation tasks;
a modem controller circuit coupled to the plurality of modem interfaces, the modem controller circuit having functionality to convert analog signals from the plurality of modem interfaces to digital signals;
an Ethernet device coupled to the modem controller circuit, the Ethernet device converting the digital signals to Ethernet format signals; and
a controller coupled to the plurality of modem interfaces, the controller executing control functions for the multiple modem apparatus.

2. The apparatus of claim 1 wherein the controller provides synchronization of the plurality of modem interfaces.

3. The apparatus of claim 1 and further including a power supply coupled to the plurality of modem interfaces and the controller, the power supply generating voltages for operation of the apparatus.

4. The apparatus of claim 1 and further including:
a plurality of RJ11 connectors coupled to the plurality of modem interfaces; and
at least one Ethernet connector coupled to the Ethernet device.

5. A multiple modem apparatus comprising:
a plurality of modem cards comprising:
a plurality of modem interfaces, each modem interface comprising analog circuitry for performing modulation and demodulation tasks;
a modem controller circuit coupled to the plurality of modem interfaces, the modem controller circuit having functionality to convert analog signals from the plurality of modem interfaces to digital signals; and
an Ethernet device coupled to the modem controller circuit, the Ethernet device converting the digital signals to Ethernet format signals; and
a controller coupled to the plurality of modem cards, the controller providing control functions for the multiple modem apparatus.

6. The apparatus of claim 5 and further including:
a plurality of RJ11-type connectors coupled to the plurality of modem cards; and
at least one RJ45-type connector coupled to the Ethernet device.

7. The apparatus of claim 5 wherein the controller provides a routing of data function for the multiple modem apparatus.

8. The apparatus of claim 5 wherein at least one of the plurality of modem cards is compliant with a G.SHDSL standard.

9. A multiple modem apparatus comprising:
a plurality of modem cards comprising:
a plurality of analog front ends, each analog front end comprising circuitry for performing modulation and demodulation tasks;
a modem controller circuit coupled to the plurality of analog front ends, the modem controller circuit having functionality to convert analog signals from the plurality of analog front ends to digital signals; and
an Ethernet device coupled to the modem controller circuit, the Ethernet device converting the digital signals to Ethernet format signals; and
a controller coupled to the plurality of modem cards, the controller providing control functions for the multiple modem apparatus.

10. The apparatus of claim 9 wherein the controller provides point-to-point protocol processing for data received from at least one of the plurality of modem cards.

11. The apparatus of claim 9 wherein the modem controller circuit comprises a coder/decoder function and a digital signal processor function.

12. A multiple modem apparatus comprising:
a plurality of analog front ends each comprising circuitry for performing modulation and demodulation tasks;
a modem controller circuit coupled to the plurality of analog front ends, the modem controller circuit having functionality to convert analog signals from the plurality of analog front ends to digital signals;
an Ethernet device coupled to the modem controller circuit, the Ethernet device converting the digital signals to Ethernet format signals; and
a controller coupled to the plurality of analog front ends, the controller providing control functions for the multiple modem apparatus.

13. The apparatus of claim 12 wherein the modem controller circuit comprises:
a coder/decoder function that digitizes the analog signals from the plurality of analog front ends to generate the digital signals; and
a digital signal processor function that processes the digital signals from the coder/decoder function.

14. A multiple modem apparatus comprising:
a plurality of analog front ends each comprising circuitry for performing modulation and demodulation tasks;
a coder/decoder function, coupled to the plurality of analog front ends, that samples, quantizes, and digitizes analog signals from the plurality of analog front ends to generate digital signals;
a digital signal processor function, coupled to the coder/decoder function, that processes the digital signals;
an Ethernet device coupled to the digital signal processor function, the Ethernet device converting the digital signals to Ethernet format signals; and
a controller coupled to the plurality of analog front ends, the controller providing control functions for the multiple modem apparatus.

15. The apparatus of claim 14 wherein the control functions include synchronization of the analog front ends, point-to-point protocol processing, and routing of data.

16. A multiple modem apparatus comprising:
a plurality of modem cards comprising:
a plurality of analog front ends, each analog front end comprising circuitry for performing modulation and demodulation tasks;
a coder/decoder function, coupled to the plurality of analog front ends, that samples, quantizes, and digitizes analog signals from the plurality of analog front ends to generate digital signals;
a digital signal processor function, coupled to the coder/decoder function, that processes the digital signals; and
an Ethernet device coupled to the modem controller circuit, the Ethernet device converting the digital signals to Ethernet format signals; and
a controller coupled to the plurality of modem cards, the controller providing control functions for the multiple modem apparatus.

17. A modem system comprising:
a multiple modem apparatus comprising:
a plurality of modem interfaces, each modem interface comprising analog circuitry for performing modulation and demodulation tasks;
a modem controller circuit coupled to the plurality of modem interfaces, the modem controller circuit having functionality to convert analog signals from the plurality of modem interfaces to digital signals;
an Ethernet device coupled to the modem controller circuit, the Ethernet device converting the digital signals to Ethernet format signals; and
a controller coupled to the plurality of modem interfaces, the controller providing control functions for the multiple modem apparatus; and
a test equipment, coupled to the multiple modem apparatus, that generates signals for transmission by the multiple modem apparatus and receiving signals through the multiple modem apparatus.

18. The system of claim 17 and further including a device under test, coupled to the multiple modem apparatus, that generates the signals received by the test equipment and receives the signals transmitted by the test equipment.

19. A method for communicating with a multiple modem apparatus, the method comprising:
generating digital test signals that represent subscriber signals;
converting the digital test signals to Ethernet format signals;
a codec of the multiple modem apparatus converting the Ethernet format signals to modulated analog signals; and
the multiple modem apparatus transmitting the modulated analog signals with one of a plurality of analog front ends to a device under test.

20. A method for communicating with a multiple modem apparatus, the method comprising:
a first of a plurality of analog front ends receiving modulated signals from a device under test;
the first analog front end demodulating the received signals;
a codec of the multiple modem apparatus digitizing the demodulated signals;
an Ethernet device of the multiple modem apparatus converting the digitized signals to Ethernet signals; and
transmitting the Ethernet signals to test equipment.
